(19) United States
(12) Patent Application Publication
(10) Pub. No.: US 2023/0066689 A1
(43) Pub. Date: Mar. 2, 2023

(54) INSECT CAPTURE DEVICE

(71) Applicant: Jerry Kobasiuk, Fort St. John (CA)

(72) Inventor: Jerry Kobasiuk, Fort St. John (CA)

(21) Appl. No.: 17/446,621

(22) Filed: Sep. 1, 2021

(51) Int. Cl. A01M 3/02; F16M 13/04; F16M 13/02

(52) U.S. Cl. CPC A01M 3/022; F16M 13/04; F16M 13/022

(57) ABSTRACT

An insect capture device that is configured to provide trapping of flying insects by superposing a portion of the present invention on an insect. The insect capture device includes a handle member wherein the handle member has a first portion and a second portion that are telescopically coupled. A head member is secured to the end of the second portion of the handle member. The head member is secured to the handle member with a swivel mount so as to provide movable adjustment thereof. The head member is planar in manner and includes a central portion. The central portion has an outer surface with an adhesive disposed thereon. The central portion has surroundably mounted thereto a circumferential border member. The circumferential border member is thicker than the central portion so as to inhibit the central portion from touching a surface on which the head member has been placed.

### FIELD OF THE INVENTION

The present invention relates generally to insect removal, more specifically but not by way of limitation, an insect removal device that is configured to provide trapping of an insect when the head of the present invention is superposed the insect.

### BACKGROUND

In most climates there are hundreds of types of insects that are prevalent and live in the same areas as people. The type of common insects can include but are not limited to ants, roaches as well as many types of flying Insects such as wasps, bees and flies. Most commercial and residential facilities are treated for the type of indigenous insects so as to inhibit these insects from invading the structures. The treatment however can only treat for those type of insects that traverse along the ground as this is where treatment can be applied. Flying insects are more challenging to control.

One method of controlling insects such as but not limited to flies is through use of devices such as but not limited to a flyswatter. These devices are well known in the art and are used to individually target a fly or similar flying insect in order to eliminate. These devices eliminate the insect through impact thereon which can result in an undesirable material being left on a window or table. This then requires additional subsequent cleaning of the area where the insect was eliminated. Additionally, utilization of a conventional flyswatter or similar device requires a swift movement which can sometimes cause the insect to fly away prior to being able to eliminate it.

Accordingly, there is a need for an insect capture device that can be utilized to trap a flying insect without destruction of the body thereof and wherein the insect capture device would eliminate any insect matter from being smeared onto a surface during use.

### SUMMARY OF THE INVENTION

It is the object of the present invention to provide an insect capture device that is configured to provide capture of flying insects wherein the present invention includes a handle member having a first portion and a second portion.

Another object of the present invention is to provide an insect capture device operable to provide elimination of flying insects wherein the present invention includes a head member wherein the head member is adjustably coupled to the end of the second portion of the handle.

A further object of the present invention is to provide an insect capture device that is configured to provide capture of flying insects wherein the head member in a preferred embodiment is square in shape and includes a central portion.

Still another object of the present invention is to provide an insect capture device operable to provide elimination of flying insects wherein the central portion of the head portion has a circumferential border on the edges thereof.

An additional object of the present invention is to provide an insect capture device that is configured to provide capture of flying insects wherein the central portion of the head member has an adhesive on the outer surface thereof.

Yet a further object of the present invention is to provide an insect capture device operable to provide elimination of flying insects wherein the circumferential border extends outward from the central portion so as to inhibit the central portion from contacting a surface on which the head portion is being placed.

Another object of the present invention is to provide an insect capture device that is configured to provide capture of flying insects wherein the handle member further includes a suction cup holder secured thereto distal to the head member.

Still an additional object of the present invention is to provide an insect capture device operable to provide elimination of flying insects and further including a swivel mount wherein the swivel mount is utilized to movably couple the head member to the handle.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of the present invention.

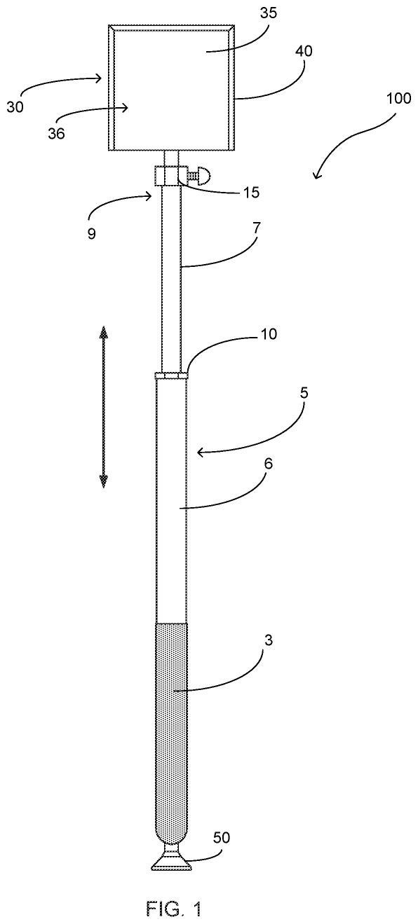

### DETAILED DESCRIPTION

Referring now to the drawings submitted herewith, wherein various elements depicted therein are not necessarily drawn to scale and wherein through the views and figures like elements are referenced with identical reference numerals, there is illustrated an insect capture device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to Figures submitted as a part hereof, the insect capture device 100 includes a handle member 5. The handle member 5 includes a first portion 6 and a second portion 7. The handle member 5 is manufactured from a lightweight rigid material such as but not limited to metal. The first portion 6 is formed to be hollow so as to slidably receive the second portion 7 therein. The second portion 7 is slidably coupled to the first portion 6 so as to provide an ability to extend the overall length of the handle member 5. While no particular is required, it is contemplated within the scope of the present invention that the handle member 5 could be expanded from a length of twelve inches to a length of twenty-four inches. A keeper 10 is operably coupled to the first portion 6 and is configured to provide locking of the second portion 7 in a desired position. It should be understood by those skilled in the art that numerous types of mechanical fasteners and coupling could be utilized to provide adjustment of the second portion 7.

Secured to the second end 9 of the second portion 7 is swivel mount 15. The swivel mount 15 is secured to the second end 9 utilizing suitable durable mechanical techniques. The swivel mount 15 provides adjustment of the head member 30 both in rotational and pivotal movements. It should be understood within the scope of the present invention that various types of mechanical fasteners could be employed so as to provide the desired movement of the head member 30.

Secured to the swivel mount 15 is the head member 30. The head member 30 is planar in manner and square in shape. While a square shape is desired in the preferred embodiment of the present invention, it is contemplated within the scope of the present invention that the head member 30 could be provided in alternate shapes. The head member 30 includes a central portion 35. The central portion 35 has an outer surface 36. The central portion 35 has an adhesive disposed on the outer surface 36 wherein the adhesive will function to adhere to an insect ensuing the head member 30 being superposed the insect. It is contemplated within the scope of the present invention that the central portion 35 could have a removable substrate with adhesive secured thereto for replacement thereof. Alternatively, as described herein, the central portion 35 would have an adhesive on the outer surface 36 operable to adhere to insects.

The head member 30 includes a circumferential border member 40. The circumferential border member 40 is surroundably mounted to the central portion 35 utilizing suitable techniques. The circumferential border member 40 is configured so as to extend outward from the central portion 35. The formation of the circumferential border member 40 inhibits the central portion 35 from contacting a surface on which the head member 30 is placed. As the circumferential border member 40 has a diameter that is larger than that of the thickness of the central portion 35, the central portion 35 will not contact a surface on which the head member 30 has been superposed wherein an insect is present. The circumferential border member 40 creates a void between the surface on which the insect is located and the central portion 35. This void facilitates the trapping of the insect upon the insect attempting to fly resulting in contact with the adhesive of the central portion 35. It is contemplated within the scope of the present invention that the head member 30 in a preferred embodiment is four inches by four inches in size. The circumferential border member 40 is manufactured from a soft non-marking plastic and is preferred to have a diameter of approximately one-quarter of an inch.

A suction cup holder 50 is secured to the handle member 5. The suction cup holder is a conventional suction cup and is operable to secure the insect capture device 100 in a desired location when not in use. While illustrated at the end of the handle member 5, it should be understood within the scope of the present invention that the suction cup holder 50 could be positioned in alternate locations. Additionally, when not in use the central portion 35 can effectively provide trapping of flying insects similar to that of conventional fly paper. The first portion 6 of the handle member 5 further includes a foam grip 3. The foam grip 3 is provided for improved comfort and engagement of the handle member 5.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An insect capture device comprising:
a handle member, said handle member having a first end and a second end;
a head member, said head member being movably secured to said second end of said handle member, said head member having a central portion, said central portion being planar in manner, said central portion having an outer surface, said central portion having peripheral edges; and
a circumferential border member, said circumferential border member being secured to said peripheral edges of said central portion, said circumferential border having a thickness that is greater than that of a thickness of the central portion.

2. The insect capture device as recited in claim 1, wherein the outer surface of said central portion includes an adhesive disposed thereon.

3. The insect capture device as recited in claim 1, wherein the outer surface has removably secured thereto a substrate wherein the substrate includes an adhesive coating thereon.

4. The insect capture device as recited in claim 1, wherein the handle member further includes a first portion and a second portion, wherein the second portion is telescopically coupled to the first portion.

5. The insect capture device as recited in claim 1, and further including a swivel mount, said swivel mount configured to operably coupled the head member to said handle member.

6. The insect capture device as recited in claim 1, wherein said handle member further includes a suction cup holder secured thereto distal to said head member.

7. An insect capture device configured to assist a user in elimination of a flying insect wherein the insect capture device comprises:
a handle member, said handle member having a first end and a second end, said handle member including a first portion and a second portion, said second portion being telescopically coupled to said first portion;
a head member, said head member being movably secured to said second end of said handle member, said head member having a central portion, said central portion being planar in manner, said central portion having an outer surface, said central portion having an adhesive disposed on the outer surface thereof;
a swivel mount, said swivel mount being secured to said second portion of said handle member, said swivel mount operably coupling the head member to said handle member, said swivel mount providing rotational and pivotal movement of said head member; and
a circumferential border member, said circumferential border member being secured to peripheral edges of said central portion, said circumferential border having a thickness that is greater than that of a thickness of the central portion.

8. The insect capture device configured to assist a user in elimination of a flying insect as recited in claim 7, and further including a keeper, said keeper configured to releasably secure said second portion of said handle member to said first portion member so as to provide a fixed position of a desired length for the handle member.

9. The insect capture device configured to assist a user in elimination of a flying insect as recited in claim 8, wherein said circumferential border member is manufactured from a non-marking plastic.

10. The insect capture device configured to assist a user in elimination of a flying insect as recited in claim 9, wherein said head member is four inches by four inches in size.

11. The insect capture device configured to assist a user in elimination of a flying insect as recited in claim 10, wherein said handle member can be adjusted to a length between twelve inches and twenty four inches.

12. The insect capture device configured to assist a user in elimination of a flying insect as recited in claim 11, and further including a suction cup holder, said suction cup holder secured to said handle member.
